(19) United States
(12) Patent Application Publication
(10) Pub. No.: US 2025/0222801 A1
(43) Pub. Date: Jul. 10, 2025

(54) LOWER LOSS CHARGING CABLE

(71) Applicant: Southwire Company, LLC, Carrollton, GA (US)

(72) Inventor: Stephen Lee Spruell, Bremen, GA (US)

(73) Assignee: Southwire Company, LLC, Carrollton, GA (US)

(21) Appl. No.: 18/848,022

(22) PCT Filed: Mar. 20, 2023
(86) PCT No.: PCT/US2023/064711

§ 371 Date: Sep. 17, 2024

Related U.S. Application Data
(60) Provisional application No. 63/321,177, filed on Mar. 18, 2022.

(51) Int. Cl. B60L 53/18; B60L 53/302

(52) U.S. Cl. CPC B60L 53/18; B60L 53/302

(57) ABSTRACT

A liquid cooled cable may be provided. The liquid cooled cable may comprise a plurality of coolant supply tubes, a coolant return tube, and a jacket. A first one of the plurality of coolant supply tubes may include a first conductor and a second one of the plurality of coolant supply tubes includes a second conductor. The coolant return tube may receive coolant from the plurality of coolant supply tubes. The plurality of coolant supply tubes and the coolant return tube may be disposed in the jacket.

This application is being filed on Mar. 20, 2023, as a PCT International Patent application and claims the benefit of and priority to U.S. Provisional patent application Ser. No. 63/321,177, filed Mar. 18, 2022, the entire disclosure of which is incorporated by reference herein in its entirety.

### BACKGROUND

An Electric Vehicle (EV) charging system, also called an electric recharging point, a charging point, a charging station a charge point, and an Electric Vehicle Supply Equipment (EVSE), is an element in an infrastructure that supplies electric energy for recharging electric vehicles, such as plug-in electric vehicles, including electric cars, neighborhood electric vehicles, and plug-in hybrids. Because plug-in hybrid electric vehicles and battery electric vehicle ownership is expanding, there is a growing need for widely distributed publicly accessible charging stations, some of which support faster charging at higher voltages and currents than are available from residential EVSEs. Many charging stations are on-street facilities provided by electric utility companies or located at retail shopping centers and operated by private companies. These charging stations provide one or a range of heavy duty or special connectors that conform to the variety of electric charging connector standards.

### BRIEF DESCRIPTION OF THE FIGURES

The accompanying drawings, which are incorporated in and constitute a part of this disclosure, illustrate various embodiments of the present disclosure. In the drawings:

FIG. 1 shows a liquid cooled cable; and

FIG. 2 shows a liquid cooled cable.

### DETAILED DESCRIPTION

### Overview

A liquid cooled cable may be provided. The liquid cooled cable may comprise a plurality of coolant supply tubes, a coolant return tube, and a jacket. A first one of the plurality of coolant supply tubes may include a first conductor and a second one of the plurality of coolant supply tubes includes a second conductor. The coolant return tube may receive coolant from the plurality of coolant supply tubes. The plurality of coolant supply tubes and the coolant return tube may be disposed in the jacket.

Both the foregoing overview and the following example embodiments are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A charging system may be used to charge a battery or batteries, for example, an electric vehicle's batteries. Consistent with embodiments of the disclosure, electric vehicles may comprise, but are not limited to, electric cars, neighborhood electric vehicles, fork lifts, delivery trucks, busses, plug-in hybrids, etc. When batteries are charged, the time required to charge the batteries may be governed by the amount of current that a charging system can deliver to the batteries. One of the limiting factors for increasing the amount of charge current to the batteries and therefore reducing the amount of charge time may be the cable that connects an electric power source to the batteries.

Conventional systems may use an air cooled charging cable in battery charging applications, for example, in applications where the charging current is below 200A. As the electric charging current increases above 200A, the corresponding required size of the charging cable used to charge the batteries may become too large, too heavy, and too inflexible for a consumer to use. Consistent with embodiments of the disclosure, a liquid cooled charging cable may be provided. The liquid cooled charging cable may supply currents (e.g., 400A to 2,000A or higher) that may be 2 to 5 times as much as the currents supplied by the conventional air cooled charging cable, but unlike the conventional air cooled charging cable, in a size, weight, and flexibility suitable for a consumer to use.

Consistent with embodiments of the disclosure, liquid coolant from a cooling device may be pumped directly around electrical conductors (e.g., bare, uninsulated) and into an charging handle attached to a cable including the electrical conductors in order to cool these components. Accordingly, cooling of the electrical conductor and the charging handle by the coolant may greatly limits thermal resistance in the electrical conductors due to heating caused by high electrical currents in the these components.

Temperature distribution in a liquid cooled EV cable from end to end for the current delivery and return circuit may be demonstrated. There may be a potential for reducing the maximum temperature of conductors supplying current to a charging plug and the same for return current by separating the return coolant flow and not having it flow over one of the conductors supplying current to the charging plug. By separating the return coolant flow, the resistance of some of the conductors carrying the current may be lowered due to a lower temperature of the conductor.

Resistance in a conductor may increase with temperature. The total power loss (i.e., I²R loss) along the supply and return paths may be lowered on some of the conductors in the charging cable by having the return flow not flowing over a conductor. A lower loss cable may result in less waste heat needing to be removed and lower operating temperature for the cable. This may be important as megawatt charging cables may be designed for faster vehicle charging.

Limiting factors in the charging cable design may be material temperature limitations, boiling point limitations for the cooling fluid, or limitations of maximum safe handling temperatures on the outer surfaces of the charging cable. The charging plug may have a handle on it in many cases. The temperature of the charging handle may reach uncomfortable temperatures in certain conditions such as a hot ambient operating condition. Consistent with embodiments of the disclosure, a cooling cable that has an auxiliary coolant supply tube may feed coolant directly to a charging handle for reduced charging handle temperature when necessary, for example.

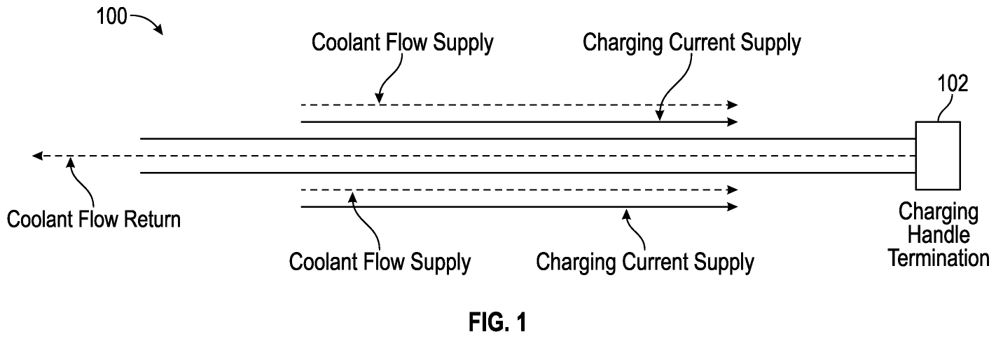

FIG. 1 shows a liquid cooled cable 100 with a charging handle 102. As shown in FIG. 1, a first coolant flow supply and a first charging current supply may flow together in liquid cooled cable 100 toward charging handle 102 connected to an EV for example. The first coolant flow supply may be used to cool a first conductor that may carry the first charging current supply. In addition, a second coolant flow supply and a second charging current supply may flow together in liquid cooled cable 100 toward charging handle 102. The second coolant flow supply may be used to cool a second conductor that may carry the second charging current supply. (In other embodiments, the second conductor may act as a return for the first charging current supply.) Both the first coolant flow supply and the second coolant flow supply may be redirected (e.g., by charging handle 102) into a coolant flow return to a coolant source that may re-cool the coolant and reuse it in the first coolant flow supply and the second coolant flow supply.

By separating the return coolant path into a return tube away from the conductors, liquid cooled cable 100 may be configured such that all the current supply conductors have conditioned supply coolant at the lowest temperature at the current supply end. The coolant may be heated on the path to the plug pins at the other end of the conductors at charging handle 102. The coolant flows may then be combined into one or more coolant return tubes. This may result in a lower sum of the I²R losses for a given plurality of conductors in a cable.

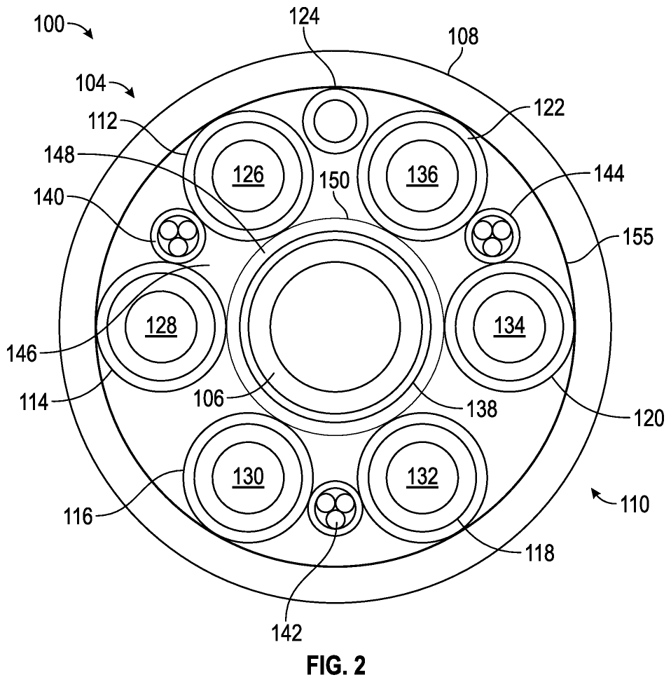

FIG. 2 shows liquid cooled cable 100 consistent with embodiments of the disclosure. As shown in FIG. 1, liquid cooled cable 100 may a comprise plurality of coolant supply tubes 104, a coolant return tube 106, a jacket 108, and a plurality of signal sub-cables 110.

Plurality of coolant supply tubes 104 may comprise a first coolant supply tube 112, a second coolant supply tube 114, a third coolant supply tube 116, a fourth coolant supply tube 118, a fifth coolant supply tube 120, a sixth coolant supply tube 122, and a handle coolant supply tube 124. First coolant supply tube 112 may include a first conductor 126, second coolant supply tube 114 may include a second conductor 128, third coolant supply tube 116 may include a third conductor 130, fourth coolant supply tube 118, may include a fourth conductor 132, fifth coolant supply tube 120 may include a fifth conductor 134, and sixth coolant supply tube 122 may include a sixth conductor 136. Handle coolant supply tube 124 may not include a conductor.

A coolant may be supplied to each of plurality of coolant supply tubes 104. A flow of this coolant may be in a direction toward charging handle 102. The coolant flowing in plurality of coolant supply tubes 104 may be used to cool respective conductors (i.e., first conductor 126, second conductor 128, third conductor 130, fourth conductor 132, fifth conductor 134, and sixth conductor 136) disposed in plurality of coolant supply tubes 104. Some or all of the conductors disposed in plurality of coolant supply tubes 104 may be used to carry a charging current (e.g., to charge an EV) via charging handle 102. Some of the conductors disposed in plurality of coolant supply tubes 104 may be used to return the charging current.

Spacers may be placed around respective conductors disposed in plurality of coolant supply tubes 104 in order to keep the conductors centered in plurality of coolant supply tubes 104 for example. The spacers may improve consistency of heat transfer from the conductors to the coolant and reduce potential hot spots in the conductors or plurality of coolant supply tubes 104. These conductor centering spacers may be helically wound around the conductors or may be longitudinal such as ribs or other features that may keep the conductor centered while also allowing for sufficient coolant flow.

The coolant flowing in plurality of coolant supply tubes 104 may be redirected (e.g., by a manifold or other device in charging handle 102) into coolant return tube 106. Coolant return tube 106 may return the coolant to the coolant source that may re-cool the coolant that was heated by the conductors. This re-cooled coolant may be reused in plurality of coolant supply tubes 104 (e.g., circulated). While FIG. 1 shows one coolant return tube at the center of liquid cooled cable 100, embodiments of the disclosure may comprise any number of coolant return tubes located anywhere inside jacket 108.

A separate coolant supply may be feed to charging handle 102 for enhanced cooling of charging handle 102 as needed. Handle coolant supply tube 124 may supply this separate coolant supply for charging handle 102. The coolant supplied by handle coolant supply tube 124 may be redirected (e.g., by charging handle 102) into coolant return tube 106. Handle coolant supply tube 124 may not include a conductor so that the coolant supplied by handle coolant supply tube 124 may not be heated by a conductor so that it may still be cool when it gets to charging handle 102.

Coolant return tube 106 may include a layer 138 that may be disposed around coolant return tube 106. Layer 138, for example, may comprise a ground conductor for liquid cooled cable 100. Layer 138 may comprise a braided conductor that may be added over coolant return tube 106 for desired ground potential. Layer 138 may also reinforce coolant return tube 106 for increased burst pressure and service life. A ground wire (e.g., bare or insulated) may be placed in liquid cooled cable 100.

Plurality of signal sub-cables 110 may comprise a first signal sub-cable 140, a second signal sub-cable 142, and a third signal sub-cable 144. These control/signal wires may be incorporated into liquid cooled cable 100 as needed and may be placed in areas to reduce the maximum temperature on an outer jacket of ones of plurality of signal sub-cables 110. The control/signal wires may be shielded with a tape or another means and may also include a drain wire in contact with the shielding tape. Cable filler materials may be placed around ones of plurality of signal sub-cables 110 to further limit temperatures of these cables.

Liquid cooled cable 100 may further include a high thermal conductivity material 146 and a low thermal conductivity material 148 (e.g., filler materials). A transition point 150 may exist between high thermal conductivity material 146 and low thermal conductivity material 148. These filler materials may be an extruded polymer or fibers fed during assembly of liquid cooled cable 100. The cable filler materials may have a low, medium, or high thermal conductivity to conduct heat or retard heat transfer (i.e., thermal insulation). The cable filler materials may also have a low, medium, or high thermal capacitance as desired to optimize heat transfer characteristics of the cable. Low thermal conductivity fillers (e.g., low thermal conductivity material 148) may be used around coolant return tube 106 to reduce heat transfer to an outer portion of liquid cooled cable 100 that may have human contact. High thermal conductivity fillers (e.g., high thermal conductivity material 146) may be used in the outer portion of liquid cooled cable 100 to transfer more heat to the supplied coolant flowing along liquid cooled cable 100 around the conductors in plurality of coolant supply tubes 104 and maintain a more constant temperature around the outside of the cable.

High thermal conductivity material 146 may have, but is not limited to, a thermal conductivity between 200 (W/m*K) and 500 (W/m*K) for example. Notwithstanding, high thermal conductivity material 146 may comprise, but is not limited to, aluminum and/or copper (e.g., in tape form), carbon fibers with carbon nanotube enhancement, or graphene for example. Low thermal conductivity material 148 may have, but is not limited to, a thermal conductivity between 0.02 (W/m*K) and 0.05 (W/m*K) for example. Notwithstanding, low thermal conductivity material 148 may comprise, but is not limited to, polypropylene fillers (e.g., the thermal conductivity polypropylene fillers may be based on looseness or compaction of the fillers with air space in between the fillers), air, polyethylene, carbon based materials, fiberglass, highly filled graphite in polyamide 6, unfilled polyamide 6, and jute fillers for example.

An overall element 155 (e.g., a tape) may be placed around the cable assembly with a high thermal conductivity coating touching plurality of coolant supply tubes 104. This may further enhance heat transfer by moving heat from plurality of coolant supply tubes 104 to the surrounding thermal mass of the fillers surrounding plurality of coolant supply tubes 104. Overall element 155 (e.g., a tape) may be a single layer of material or a multilayer such as mylar and aluminum tape for example. Overall element 155 (e.g., a tape) may also function to limit Electromagnetic interference (EMI) for the cable assembly.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A cable comprising:
a plurality of coolant supply tubes, wherein a first one of the plurality of coolant supply tubes includes a first conductor and a second one of the plurality of coolant supply tubes includes a second conductor;
a coolant return tube that receives coolant from the plurality of coolant supply tubes; and
a jacket in which the plurality of coolant supply tubes and the coolant return tube are disposed.

2. The cable of claim 1, further comprising at least one signal sub-cable.

3. The cable of claim 1, further comprising a low thermal conductivity material disposed around the coolant return tube.

4. The cable of claim 1, further comprising a high thermal conductivity material disposed around at least one of the plurality of coolant supply tubes.

5. The cable of claim 1, wherein the plurality of coolant supply tubes are disposed around the coolant return tube.

6. The cable of claim 1, wherein the coolant return tube is disposed in a center of the cable.

7. The cable of claim 1, wherein the coolant return tube is concentric with the jacket.

8. The cable of claim 1, wherein at least one of the plurality of coolant supply tubes supplies coolant to cool a charging handle disposed at an end of the cable.

9. The cable of claim 1, wherein the plurality of coolant supply tubes are adjacent to the jacket.

10. The cable of claim 1, wherein the plurality of coolant supply tubes are adjacent to the coolant return tube.

11. The cable of claim 1, further comprising a layer disposed around the coolant return tube comprising a ground conductor.

12. The cable of claim 11, wherein the ground conductor is braided.

13. The cable of claim 1, wherein the first conductor provides a current supply path and the second conductor provides a current return path.

14. A cable comprising:
a plurality of coolant supply tubes, wherein a first one of the plurality of coolant supply tubes includes a first conductor and a second one of the plurality of coolant supply tubes includes a second conductor wherein a high thermal conductivity material is disposed around each of the plurality of coolant supply tubes;
a coolant return tube that receives coolant from the plurality of coolant supply tubes wherein a low thermal conductivity material disposed around the coolant return tube; and
a jacket in which the plurality of coolant supply tubes and the coolant return tube are disposed wherein the plurality of coolant supply tubes are adjacent to the coolant return tube and wherein the plurality of coolant supply tubes are adjacent to the jacket.

15. The cable of claim 14, further comprising a layer disposed around the coolant return tube comprising a ground conductor.

16. The cable of claim 15, wherein the first conductor provides a current supply path and the second conductor provides a current return path.

17. The cable of claim 16, wherein at least one of the plurality of coolant supply tubes supplies coolant to cool a charging handle disposed at an end of the cable.

18. A cable comprising:
a plurality of coolant supply tubes, wherein a first one of the plurality of coolant supply tubes includes a first conductor and a second one of the plurality of coolant supply tubes includes a second conductor wherein the first conductor provides a current supply path and the second conductor provides a current return path and wherein at least one of the plurality of coolant supply tubes supplies coolant to cool a charging handle disposed at an end of the cable and wherein the at least one of the plurality of coolant supply tubes that supplies coolant to cool the charging handle does not include a conductor;
a coolant return tube that receives coolant from the plurality of coolant supply tubes; and
a jacket in which the plurality of coolant supply tubes and the coolant return tube are disposed.

19. The cable of claim 18, further comprising a layer disposed around the coolant return tube comprising a ground conductor.

20. The cable of claim 18, further comprising a low thermal conductivity material disposed around the coolant return tube and further comprising a high thermal conductivity material disposed around at least one of the plurality of coolant supply tubes.
